(19) United States
(12) Patent Application Publication
(10) Pub. No.: US 2014/0136292 A1
(43) Pub. Date: May 15, 2014

(54) Method of Providing Accessible Remodeling Services through a Franchise Arrangement

(71) Applicant: Totally Accesible Homes, LLC, Ailey, GA (US)

(72) Inventor: Monti Marsters, Lawrenceville, GA (US)

(73) Assignee: Totally Accesible Homes, LLC, Ailey, GA (US)

(21) Appl. No.: 14/082,046

(22) Filed: Nov. 15, 2013

Related U.S. Application Data
(60) Provisional application No. 61/727,102, filed on Nov. 15, 2012.

(51) Int. Cl. G06Q 10/06

(52) U.S. Cl. CPC G06Q 10/0637
USPC 705/7.36

(57) ABSTRACT

A method of disability remodeling services for adapting a home or other building, structure, or location for accessibility to the disabled is disclosed. A franchisor having a brand is established to conduct product development and testing, develop uniform practices for product recommendation and installation, and train franchisee employees in recommending and deploying products according to the uniform practices. A plurality of franchisees under the brand provide consultation, installation, and remodeling services to customers. A primary goal of the franchisor's marketing is to associate the brand with a high level of knowledge and skill at understanding and addressing the facility needs of disabled individuals. Existing services within the generally delineated category of aging-in-place remodeling generally specialize in one particular type of facility, such as wheelchair lifts, elevators, stair lifts, accessible tubs and showers, or accessible cabinets. Existing services generally do not provide a full range of products or planning expertise.

### CROSS-REFERENCE TO RELATED APPLICATIONS

This application claims priority to U.S. Provisional Application No. 61/727,102, filed Nov. 15, 2012, which is hereby incorporated by reference.

STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to methods of providing construction and remodeling services and in particular to methods of providing uniformly trained consultants and technicians, uniformly designed and manufactured products, and uniformly conducted installation and construction services in furtherance of updated, adapting, and retrofitting homes and other buildings, structures, or locations to improve the facility's accessibility to disabled individuals. Numerous products, techniques and equipment are known in the field of disability remodeling, but knowledge of them and their particular advantages, disadvantages, costs as well as the skills necessary to deploy them are not readily available.

At the same time, as an individual becomes disabled, for example by advancing age or through an accident, the individual and his or her family or caretakers often face numerous costs of both money and time both in obtaining medical and personal care for the disabled person and in preparing the disabled person to live and possibly work on his or own. The time and money costs of preparing the person's living and possibly working environment can be reduced by providing widely available expert consultation services that come with a uniformly high knowledge level and approach (thus reducing the time required for the disabled individual or caretakers to research solutions) and a uniformly available collection of disability-related products, fixtures, and installation services (thus reducing the money cost by taking advantage of economies of scale shared between different disabled individuals with different special needs).

### SUMMARY OF THE INVENTION

Accordingly, the invention is directed to a method of providing uniform knowledge and advice, uniform product selection and installation, and a uniform basket of products for adapting a home or other building, structure, or location for accessibility to the disabled. A franchisor entity having a brand is established to conduct product development and testing, develop uniform practices for product recommendation and installation, and train franchisee employees in recommending and deploying products according to the uniform practices. A plurality of franchisees under the brand provide consultation, installation, and remodeling services to customers, each within a geographically or otherwise-defined region. The franchisor supports the franchisee efforts through marketing across the franchisee areas, for example nationally or globally. A primary goal of the franchisor's marketing is to associate the brand with a high level of knowledge and skill at understanding and addressing the facility needs of disabled individuals. Existing services within the generally delineated category of aging-in-place remodeling generally specialize in one particular type of facility, such as wheelchair lifts, elevators, stair lifts, accessible tubs and showers, or accessible cabinets. Existing services generally do not provide a full range of products or planning expertise.

It is an object of the invention to make broad disability remodeling services available to disabled individuals and their families through a single source, as opposed to specialist sources in particular types of facilities.

It is an object of the invention to make disability remodeling services available on a local basis through person-to-person experts in advising disabled individuals and their families on what facilities will work the best for their particular needs.

It is an object of the invention to make disability remodeling services available on a large scale basis to many disabled individuals and their families over a large market region so as to reduce the marginal cost of disability remodeling services to disabled individuals and their families.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

No drawing is provided for the disclosed invention because a drawing is not necessary for the understanding of the invention under 35 U.S.C. §113, 37 C.F.R. §1.81(a), and MPEP §608.02 (III) (A).

### DETAILED DESCRIPTION OF THE INVENTION

Referring now to the invention in more detail, the invention is directed to a method of a method of providing uniform knowledge and advice, uniform product selection and installation, and a uniform basket of products for adapting a home or other building, structure, or location for accessibility to the disabled. The method centers on the provision of a franchisor entity that develops a sophisticated basket of goods and services and provides supply, marketing, and training to a plurality of franchisees that are geographically local to the customer. The franchisees are responsible for local marketing and production of services to the customer. Revenue for the franchisees is generated by sales of goods and services to customers, and revenue for the franchisor may be generated by flat or percentage-based fees paid by the franchisees, and in other ways described below.

The franchisor, practices the method of the invention by developing a basket of goods and services to offer related to disability-remodeling and aging-in-place remodeling. The service practices may be based on an existing business already in local, non-franchise, operation or may be developed from scratch. The service practices include a consultation aspect, which may take the form of formal or informal institutional knowledge that relates different disability conditions, user needs, and building features to different types of disability facilities. The consultation aspect may be formalized via the creation of training programs and materials, such as handbooks, guides, formulae, flow charts, and the like. The service practices further include an installation and construction component, which may take the form of formal or informal skills in disparate building-related areas such as structural engineering, internal demolition, framing, plumbing, electrical, flooring, drywall, etc., as well as specialized skills related to disability facilities such as lift and elevator installation, ramp construction, grab bar installation, wet-room construction, etc. The service practices may be formalized through the designation of newly developed certification programs in the aforementioned institutional knowledge or existing certification programs in construction and remodeling related skills and knowledge areas. Certification and training may be provided by the franchisor to the franchisees as entities, to their individual owners or managers, or their employees.

The goods basket preferably includes a wide and comprehensive variety of equipment, including multiple types of lifts and elevators, ramps, grab bars, high-friction floor elements, mechanized height-adjustable cabinets and shelving, accessible tubs and showers, emergency egress systems, etc. The goods basket may include plans or kits for features that may be installed, but are not necessarily sourced as product; for example a staircase may be rebuilt or a doorway widened to achieve improved accessibility using essentially general purpose construction materials; thus the feature may, for the purposes of the present invention, become a product or goods offering without an underlying manufactured product or good. The goods offered may be sourced from suppliers or custom-designed and manufactured by the franchisor or partner entities. The franchisor preferably engages in research and development of improved products to offer with an aim to construct a portfolio of exclusive product offerings and/or licensable intellectual property.

The basket of goods and services on offer, once set, may be adjusted later to include new technologies and techniques and to discard old ones. Once a basket is established, the franchisor obtains franchisee agreements with candidate individuals and businesses for particular geographic regions and begins training the franchisees in providing the goods and services of the basket at a high degree of quality, workmanship, and uniformity. The franchisee may make payments to the franchisor for the training of the franchisee and the franchisee's employees. Training is preferably ongoing, with the franchisee or employees being required to regularly undergo refresher or update courses. The franchisor preferably provides a number of certification programs for the franchisor in the deployment of different classes of goods and services, and in particular to the skill sets and qualifications of the franchisee's employees.

The franchisor provides wide area marketing over a region, country, or the whole world. Marketing is at least partly conducted over the Internet. Where responses to marketing from prospective customers are solicited, the franchisor may operate a central Internet, telephone, or other type of communications routing service to connect prospective customers to franchisee entities. Further marketing may be conducted at the local level by the franchisees in local television, radio, billboards, and other localized channels.

The franchisor develops a network of goods suppliers for some or all goods involved in the basket of goods and services. For major components, end product suppliers or manufacturing partners are used to ensure supply to the franchisees. Supply agreements may also be used for smaller fixtures, and general purpose materials. The franchisees may be allowed to purchase some goods or no goods from outside of the franchisor's supply network. Exactly which goods, if not all goods, are provided through the supply network is preferably determined on an ongoing basis by the volume and cost savings on supplying the particular good. The Franchisor may impose any level of restriction or minimum or maximum prices and quantities of goods purchased by the franchisees in the conduct of the business. The franchisee may generate revenue through markups on supplied goods.

The franchisor further develops, maintains, and promotes a brand identity for the business practicing the invention. The brand identity may consist of one or more trademarks or service marks. The franchisor's marketing efforts are preferably directed in large part to associating the brand identity with knowledge and competence in the area of improving buildings to make them more accessible to the disabled. Through this brand association, disabled individuals and their families may be informed of and drawn to the goods and services of the business practicing the invention, and revenue is generated for the franchisees and franchisor.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A franchise business method for supplying disability remodeling goods and services to consumers comprising:
(a) a franchisor;
(b) at least one franchisee;
(c) said franchisor being capable of supplying to said at least one franchisee a basket of disability-related goods;
(d) each good in said basket of disability related goods being suitable for installation in or use in connection with any of the group of buildings, structures, or locations;
(d) said at least one franchisee being empowered to offer said basket of disability-related goods to consumers in conjunction with a basket of related services; and
(e) said basket of related services comprising any of the group of consultation, planning, design, and installation services relating to disability remodeling.

2. The franchise business method of claim 1 wherein said franchisor expends resources on research and development of disability related goods and related methods and adds the results of said research and development to said basket of disability-related goods.

3. The franchise business method of claim 2 wherein said franchisor expends resources to obtain exclusive rights in the results of said research and development of disability-related goods and related methods, whereby the results of said research and development of disability-related goods and related methods are made exclusively available to consumers via said at least one franchisee via said basket of disability-related goods.

4. The franchise business method of claim 1 wherein said franchisor develops and retains a body of institutional knowledge, said body of institutional knowledge pertaining at least to any of the group of advice, goods selection, or goods installation for adapting a building, structure, or location for accessibility to the disabled, and wherein said franchisor providing said body of institutional knowledge to said at least one franchisee by any of the group of training programs, handbooks, guides, formulae, or flow charts.

5. The franchise business method of claim 1 wherein said franchisor expends resources to develop, maintain, and promote a brand identity shared by said franchisor and said at least one franchisee.

6. The franchise business method of claim 2 wherein said franchisor expends resources to develop, maintain, and promote a brand identity shared by said franchisor and said at least one franchisee.

7. The franchise business method of claim 3 wherein said franchisor expends resources to develop, maintain, and promote a brand identity shared by said franchisor and said at least one franchisee.

8. The franchise business method of claim 4 wherein said franchisor expends resources to develop, maintain, and promote a brand identity shared by said franchisor and said at least one franchisee.

9. The franchise business method of claim 7 wherein said franchisor explicitly promotes the association of said brand identity with said exclusive rights in the results of said research and development of disability-related goods and related methods.

10. The franchise business method of claim 8 wherein said franchisor explicitly promotes the association of said brand identity with said body of institutional knowledge.

11. The franchise business method of claim 10 wherein said franchisor provides training and certification as to said body of institutional knowledge to said any of the group of said at least one franchisee, individual owners or managers of said at least one franchisee, or individual employees of said at least one franchisee.

12. The franchise business method of claim 2 wherein said franchisor develops and retains a body of institutional knowledge, said body of institutional knowledge pertaining at least to any of the group of advice, goods selection, or goods installation for adapting a building, structure, or location for accessibility to the disabled, and wherein said franchisor providing said body of institutional knowledge to said at least one franchisee by any of the group of training programs, handbooks, guides, formulae, or flow charts.

13. The franchise business method of claim 3 wherein said franchisor develops and retains a body of institutional knowledge, said body of institutional knowledge pertaining at least to any of the group of advice, goods selection, or goods installation for adapting a building, structure, or location for accessibility to the disabled, and wherein said franchisor providing said body of institutional knowledge to said at least one franchisee by any of the group of training programs, handbooks, guides, formulae, or flow charts.

14. The franchise business method of claim 12 wherein said franchisor expends resources to develop, maintain, and promote a brand identity shared by said franchisor and said at least one franchisee.

15. The franchise business method of claim 13 wherein said franchisor expends resources to develop, maintain, and promote a brand identity shared by said franchisor and said at least one franchisee.

16. The franchise business method of claim 14 wherein said franchisor explicitly promotes the association of said brand identity with said body of institutional knowledge.

17. The franchise business method of claim 16 wherein said franchisor provides training and certification as to said body of institutional knowledge to said any of the group of said at least one franchisee, individual owners or managers of said at least one franchisee, or individual employees of said at least one franchisee.

18. The franchise business method of claim 15 wherein said franchisor explicitly promotes the association of said brand identity with said body of institutional knowledge.

19. The franchise business method of claim 18 wherein said franchisor provides training and certification as to said body of institutional knowledge to said any of the group of said at least one franchisee, individual owners or managers of said at least one franchisee, or individual employees of said at least one franchisee.

20. The franchise business method of claim 19 wherein said franchisor explicitly promotes the association of said brand identity with said exclusive rights in the results of said research and development of disability-related goods and related methods.
